(19) United States
(12) Patent Application Publication
(10) Pub. No.: US 2003/0188143 A1
(43) Pub. Date: Oct. 2, 2003

(54) 2N- way MAX/MIN instructions using N-stage 2- way MAX/MIN blocks

(75) Inventor: Gad Sheaffer, Haifa (IL)

Correspondence Address: KENYON & KENYON, 1500 K STREET, N.W., SUITE 700, WASHINGTON, DC, 20005, US

(73) Assignee: INTEL CORPORATION

(21) Appl. No.: 10/107,261

(22) Filed: Mar. 28, 2002

(51) Int. Cl. G06F 9/00

(52) U.S. Cl. 712/236; 712/223

(57) ABSTRACT

The present invention relates to a method and system for providing a 2^{N}-way comparison instruction in a processor. Specifically, a method for providing comparison instruction includes decoding an instruction as one of 2^{N}-way MAX instruction and a 2^{N}-way MIN instruction. The method also includes one of computing a maximum value for each of a plurality of pairs and computing a minimum value for each of the plurality of pairs of values. The method, further includes one of computing a maximum of the computed maximum values and computing a minimum of the computed minimum values and outputting one of the computed minimum and the computed minimum values.

### FIELD OF THE INVENTION

The present invention relates to processor architectures and instruction sets, and in particular, to processor architectures with instruction sets that provide 2^{N}-way maximum (MAX) and minimum (MIN) instructions using N-stage, two-way (2-way) MAX and/or MIN blocks.

### BACKGROUND

In modern processors, execution of instructions occurs, in general, in the following sequential order: the processor reads an instruction, a decoder in the processor decodes the instruction, and, then, the processor executes the instruction. In older processors the clock speed of the processor was generally slow enough that the reading, decoding and executing of each instruction could occur in a single clock cycle. However, modern microprocessors have improved performance by going to shorter clock cycles (that is, higher frequencies). These shorter clock cycles tend to make instructions require multiple, smaller sub-actions that can fit into the cycle time. Executing many such sub-actions in parallel, as in a pipelined and/or super-scalar processor, can improve performance even further. For example, although the cycle time of a present-day processor is determined by a number of factors, the cycle time is, generally, determined by the number of gate inversions that need to be preformed during a single cycle. Ideally, the execute stage determines the cycle time. However, in reality, this is not always the case. With the desire to operate at high frequency, the execute stage can be performed across more than one cycle, since it is an activity that can be pipelined. In a large number of workloads the added latency caused by the additional cycle(s) has only a small impact on processor performance. The ultimate goal of many systems is to be able to complete the execution of as many instructions as quickly and as efficiently as possible without adversely impacting the cycle time of the processor.

One way to increase the number of instructions, or equivalent instructions, that can be executed is to create single instructions that can perform work that currently can only be accomplished by using multiple instructions without causing any timing problems during the execute phase. Instructions of this type can be especially effective in calculating 2^{N}-way MAX and/or MIN values.

### BRIEF DESCRIPTION OF THE DRAWINGS

FIG. 1 is a block diagram of a computer system that includes an architectural state including one or more processors, registers and memory, in accordance with an embodiment of the present invention.

FIG. 2 is an exemplary structure of a processing core of the computer of FIG. 1 having a super-scalar architecture and/or Very Long Instruction Word (VLIW) architecture with multiple 2:1 MAX and/or MIN comparators implemented in N=2 consecutive execute stages for calculating 2^{N=2}=4-way MAX and/or MIN values, in accordance with an embodiment of the present invention.

FIG. 3 is a top-level block diagram of a circuit for providing four-way (4-way) sideways MAX instructions in a processor, in accordance with an embodiment of the present invention.

FIG. 4 is a detailed block diagram of a circuit for providing a four-way (4-way) Single Instruction Multiple Data (SIMD) Parallel MAX instruction in a processor, in accordance with an embodiment of the present invention.

FIG. 5 is a detailed flow diagram of a method for providing an eight-way (8-way) sideways MAX instruction in a processor, in accordance with an embodiment of the present invention.

FIG. 6 is a top-level block diagram of a circuit for providing four-way (4-way) sideways MIN instructions in a processor, in accordance with an embodiment of the present invention.

FIG. 7 is a detailed block diagram of a circuit for providing a four-way Single Instruction Multiple Data (SIMD) Parallel MIN instruction in a processor, in accordance with an embodiment of the present invention.

FIG. 8 is a detailed flow diagram of a method for providing an eight-way (8-way) sideways MIN instruction in a processor, in accordance with an embodiment of the present invention.

FIG. 9 is a top-level flow diagram of a method for providing 2^{N}-way MAX instructions and/or 2^{N}-way MIN instructions in a processor, in accordance with an embodiment of the present invention.

FIG. 10 is a detailed flow diagram of a method for providing a four-way (4-way) sideways MAX instruction in a processor, in accordance with an embodiment of the present invention.

FIG. 11 is a detailed flow diagram of a method for providing a four-way (4-way) Single Instruction Multiple Data (SIMD) parallel MAX instruction in a processor, in accordance with an embodiment of the present invention.

FIG. 12 is a detailed flow diagram of a method for providing an 8-way sideways MAX instruction in a processor, in accordance with an embodiment of the present invention.

### DETAILED DESCRIPTION

In accordance with an embodiment of the present invention, 2^{N}-way MAX and/or MIN instructions may be implemented to execute in N cycles using, for example, 2:1 MAX and/or MIN blocks in each pipe stage. Each 2:1 MAX/MIN block may compare pairs of values and select the extreme value, that is, either the maximum or the minimum value. The instruction may operate in a fully pipelined manner (that is, with a throughput of one (1) instruction every cycle) and produce a result after two (2) cycles. The 2^{N}-way MAX instructions also may use a number of special purpose registers in determining the maximum of a number of operands provided by the instruction. The special purpose registers, definitions of which are specified below, merely illustrate one possible embodiment of the present invention and should not be construed as the only possible embodiment.

In accordance with an embodiment of the present invention, the basic hardware that may be used by the 2^{N}-way MAX and/or MIN instructions may include 8-bit and 16-bit MAX and/or MIN blocks, which may be fitted easily in a single cycle of any processor. This is especially true if the processor on which the instructions are running operates on higher precision data types such as 64-bit integers and floating point numbers. For example, since the blocks are of lower computational complexity, two (2) 2:1, 16-bit MAX and/or MIN blocks may be implemented in two (2) consecutive execute stages without impacting the cycle time of the processor.

In addition, implementing the whole operation in a single instruction may provide a significant savings in the pipeline front-end instruction supply requirements, since the functionality of multiple instructions may be packed into a single instruction without causing any timing problems during the execute stage.

The impact of the 2^{N}-way MAX and/or MIN instructions on overall performance can be significant, in general, by a factor of N. For example, in accordance with an embodiment of the present invention, a four-way (4-way) MAX and/or MIN instruction, where N=2, may reduce the latency required for performing the same operation with current instructions by a factor of two (2), thus, enabling a significant speedup of applications using the 4-way MAX and/or MIN instruction. Specifically, the MAX and/or MIN instructions may enable significant speedup of the execution of a large class of applications, for example, applications for modems, speech and video.

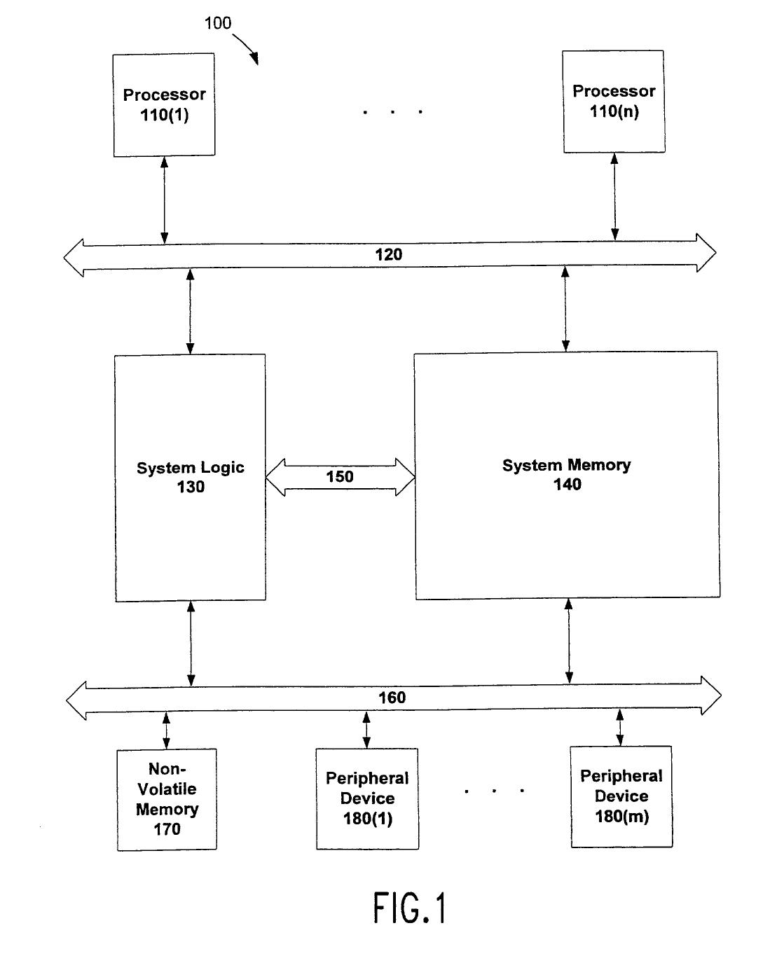

FIG. 1 is a block diagram of a computer system, which includes an architectural state, including one or more processors, registers and memory, in accordance with an embodiment of the present invention. In FIG. 1, a computer system 100 may include one or more processors 110(1)-110(n) coupled to a processor bus 120, which may be coupled to a system logic 130. Each of the one or more processors 110(1)-110(n) may be N-bit processors and may include a decoder (not shown) and one or more N-bit registers (not shown). System logic 130 may be coupled to a system memory 140 through a bus 150 and coupled to a non-volatile memory 170 and one or more peripheral devices 180(1)-180(m) through a peripheral bus 160. Peripheral bus 160 may represent, for example, one or more Peripheral Component Interconnect (PCI) buses, PCI Special Interest Group (SIG) PCI Local Bus Specification, Revision 2.2, published Dec. 18, 1998; industry standard architecture (ISA) buses; Extended ISA (EISA) buses, BCPR Services Inc. EISA Specification, Version 3.12, 1992, published 1992; universal serial bus (USB), USB Specification, Version 1.1, published Sep. 23, 1998; and comparable peripheral buses. Non-volatile memory 170 may be a static memory device such as a read only memory (ROM) or a flash memory. Peripheral devices 180(1)-180(m) may include, for example, a keyboard; a mouse or other pointing devices; mass storage devices such as hard disk drives, compact disc (CD) drives, optical disks, and digital video disc (DVD) drives; displays and the like.

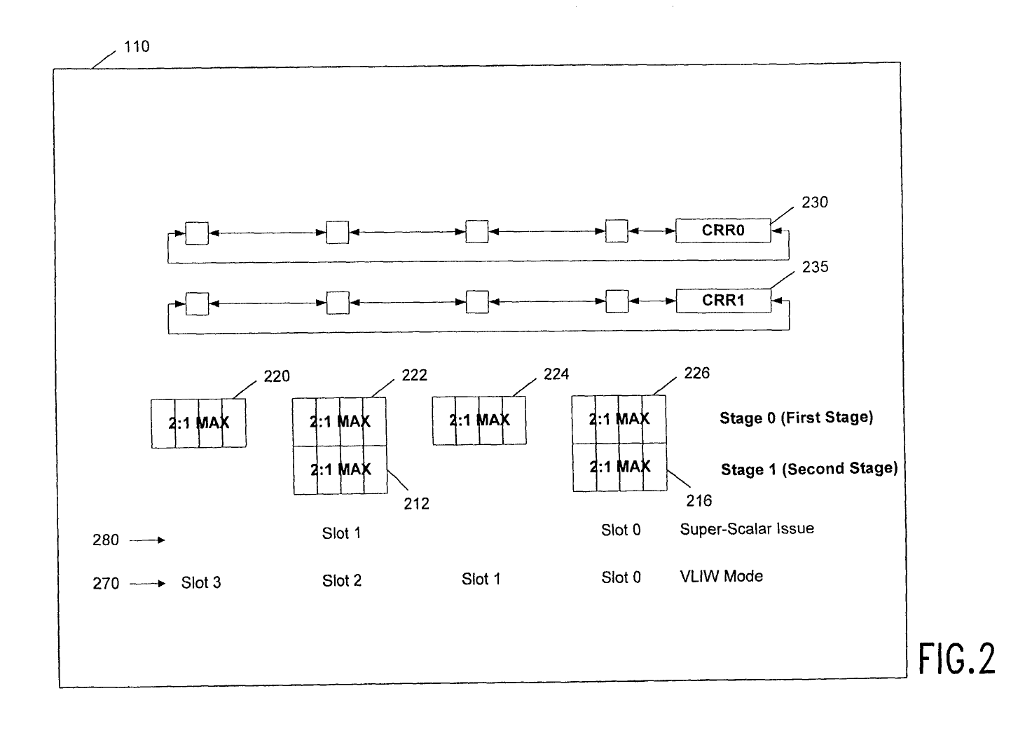

FIG. 2 is an exemplary structure of a processor 110 of the computer of FIG. 1 having a super-scalar architecture and/or VLIW architecture with multiple 2:1 MAX/MIN blocks 212, 216, 220, 222, 224 and 226 implemented in two (2) consecutive execute stages for calculating 4-way MAX and/or MIN values, in accordance with embodiments of the present invention. It should be clearly understood that the exemplary 4-way structure shown in FIG. 2 is merely illustrative of the larger inventive concept and should not be taken to limit the possible structural combinations of the present invention. For example, in eight-way (8-way) MAX and/or MIN instructions, which are 2³-way MAX/MIN instructions having 3 stages, there would be eight (8) 2:1 MAX/MIN blocks in a first stage, four (4) 2:1 MAX/MIN blocks in a second stage; two (2) 2:1 MAX/MIN blocks in a third stage; and three (3) Compare Result Registers (CRR). Similarly, for example, in sixteen-way (16-way, that is, 2⁴-way) MAX and/or MIN instructions there would be 4 stages; 4 CRR registers; and 16, 8, 4 and 2 MAX/MIN blocks in the first through fourth stages, respectively. Likewise, in FIG. 2 the designation of the blocks 212, 216, 220, 222, 224 and 226 as 2:1 MAX/MIN blocks is merely illustrative of the function of the blocks and should not be taken to limit the possible structural configurations of the 2:1 MAX/MIN blocks or imply that the 2:1 MAX/MIN blocks must be capable of performing both MAX and MIN determinations.

In FIG. 2, processor 110 also may include several common registers including, for example, CRR0 230 and CRR1 235. CRR0 230 and CRR1 235 may be implemented as shift-registers into which all the arithmetic flags generated in a cycle may be shifted. If more than one instruction causing a shift is issued to one of the CRR registers 230, 235 in the same cycle, the CRR registers 230, 235 may be shifted by the sum of the number of instructions causing the shifts. For example, a carry-out bit from each 2:1 MAX/MIN block may be stored in CRR0 230 and/or CRR1 235.

For example, all of the instructions consuming the contents of one of CRR0 230 and CRR1 235 may conditionally shift the CRR register used after reading the relevant bits out of the CRR register used. In contrast, all of the instructions modifying the CRR registers may shift the bits of the CRR register used before updating that CRR register. For example, in accordance with an embodiment of the present invention, CRR0 230 may be used for collecting flags generated by the first stage of execution, and for providing flags to the first execution stage. Likewise, CRR1 235 may perform the same function for the second execution stage and for providing flags to the second execution stage. Using CRR0 230 for the first stage flags and CRR1 235 for the second stage flags enables instructions that are writing to and/or reading from CRR0 230 and/or CRR1 235 to execute back-to-back, that is, in consecutive cycles, without conflict.

The 2^{N}-way MAX and/or MIN instructions may update the CRR bits based on the issue slot in which the instruction is executed. For example, for an instruction number, I, I may be ε{0,1} in Super-scalar mode, and I may be ε{0,1,2,3} in VLIW mode, where only the adder issue slots 270 and 280 are considered.

In order to minimize the amount of connectivity required to steer bits into and out of the CRR registers 230, 235, the instructions using the CRR registers 230, 235, in general, may be packed into the lower issue slots. This means that if N such instructions are issued, they would occupy issue slots 0 to N−1. This restriction, generally, can be easily enforced in VLIW mode, for example, in the four (4) issue slots 270 in FIG. 2. Unfortunately, in super-scalar mode it can be harder to enforce, and occasionally may cause processor 110 to stall. However, in FIG. 2, in super-scalar mode, if there are only two (2) issue slots 280, it may be easier to provide the required connectivity to enable issuing a single instruction using these registers into slot 1 rather than slot 0.

The 2^{N}-way MAX and/or MIN instructions may be described in the context of processor 110 having a Super-Scalar architecture and/or a VLIW architecture. For example, in accordance with an embodiment of the present invention, the data type may be assumed to be 16-bits and the processing core may be assumed to have a 32-bit data path and 32-bit registers. However, it should be clearly understood that this example is merely illustrative and in no way intended to limit the scope of the present invention, since the data type and processing core may be of any other precision either below or the above 16-bit data type:32-bit processing core ratio, for example, 8-bit:32-bit, 16-bit:64-bit or 32-bit:128-bit.

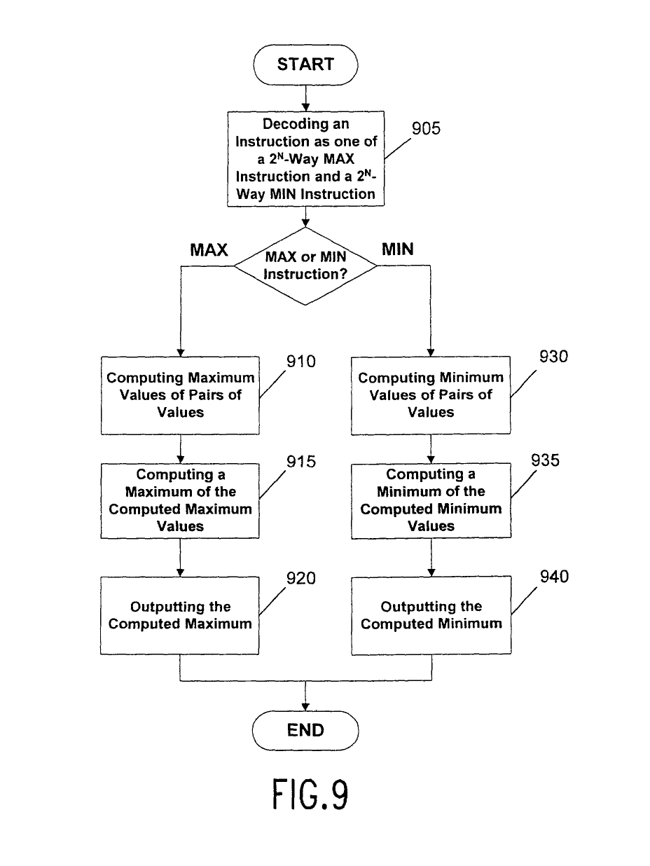

FIG. 9 is a top-level flow diagram of a method for providing 2^{N}-way MAX and/or MIN instructions in a processor, in accordance with an embodiment of the present invention. In FIG. 9, an instruction may be decoded 905 as one of a 2^{N}-way MAX instruction and/or a 2^{N}-way MIN instruction. If the instruction is determined 907 to be a 2^{N}-way MAX instruction, maximum values of pairs of values from the 2^{N}-way MAX instruction may be computed 910, a maximum of the computed maximum values may be computed 915, and the computed maximum may be stored 920. If the instruction is determined 907 to be a 2^{N}-way MIN instruction, minimum values of pairs of values from the 2^{N}-way MIN instruction may be computed 930, a minimum of the computed minimum values may be computed 935, and the computed minimum may be stored 940.

In accordance with an embodiment of the present invention, the method of FIG. 9 may be performed in two (2) cycles, where the decoding 905 and computing maximum and/or minimum values 910, 930 operations may occur in a first cycle and the computing a maximum of the computed maximum values and/or computing a minimum of the computed minimum values 915, 935 and storing 920, 940 operations may occur in a second cycle. In accordance with other embodiments of the present invention, the method of FIG. 9 also may be performed in one (1) cycle as well as three (3) or more cycles.

In accordance with an embodiment of the present invention, a generalized 4-way sideways MAX instruction may be implemented to compute the maximums of two (2) input values. For example, the 4-way sideways MAX instruction may compute maximum values from two (2) pairs of operands derived from the two (2) input values, optionally update a first CRR, compute a maximum of the computed maximum values, store the computed maximum value, and optionally update a second CRR. Specifically, the generic syntax of the 4-way sideways MAX instruction with two (2) input values may be represented by:

[CRR]destR=MAX4(srcA,srcB)

where the square brackets ([ ]) denote optional instruction parameters that are not required for execution of the instruction.

In accordance with an embodiment of the present invention, the 4-way sideways MAX instruction described below, generally, may be completely executed over two (2) processor clock cycles. However, it should be clearly understood that the instructions also may be implemented to execute over a single clock cycle as well as over three (3) or more clock cycles. In the following examples, the syntax used may include variables such as signal′ and signal″, which are delayed versions of a variable signal by one and two cycles, respectively.

In accordance with an embodiment of the present invention, the functionality of the 4-way sideways MAX instruction may be defined by the following C-style pseudo-code example:

First cycle:

Compute pairs of MAX values

tmp0=MAX(srcA.1, srcA.h)

tmp1=MAX(srcB.1, srcB.h)

Update CRR0

If CRR

| { | |
|---|---|
| Shift CRR0 left by 2 | |
| CRR0[2i] | = srcA.l > srcA.h |
| CRR0[2I + 1] | = srcB.l > srcB.h |
| } | |

Second cycle:

Compute MAX of the first cycle MAX values

destR.1=MAX(tmp0′, tmp1′)

Update CRR1

If CRR

{
Shift CRR1 left by 1
CRR0[i] = tmp0' > tmp1'
}

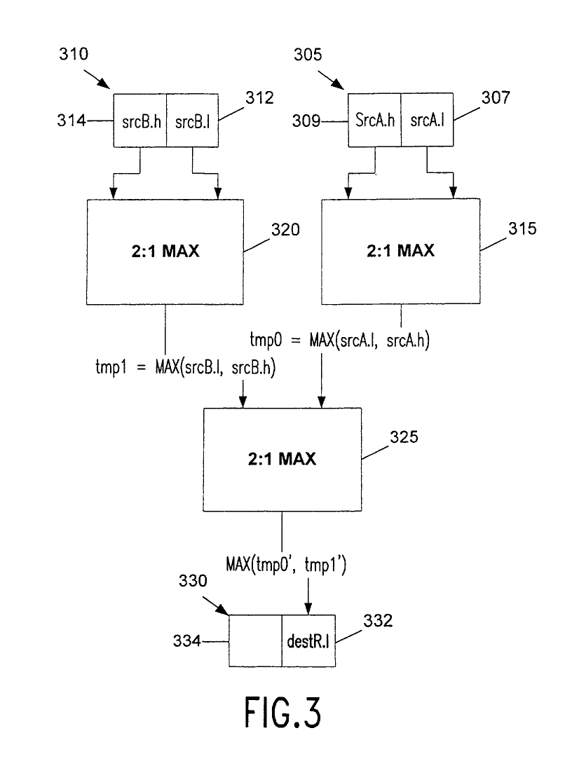

FIG. 3 is a detailed block diagram of a circuit for providing four-way (4-way) sideways MAX instructions in a processor, in accordance with an embodiment of the present invention. In FIG. 3, a first storage location 305 may include storage areas 307, 309 to store a low-bit portion of a first input value and a high-bit portion of the first input value, respectively. Similarly, a second storage location 310 may include storage areas 312, 314 to store a low-bit portion of a second input value and a high-bit portion of the second input value, respectively. The first and second storage locations 305, 310 may be implemented using, but not limited to, for example, registers and memory. Each of the first storage location 305 storage areas 307, 309 may be connected to separate inputs of a first 2:1 MAX block 315 and each of the second storage location 310 storage areas 312, 314 may be connected to separate input lines of a second 2:1 MAX block 320. Each of the first and second 2:1 MAX blocks 315, 320 may be configured to output which of the two inputs from their connected storage areas 307, 309 and 312, 314, respectively, is a maximum value. The first and second 2:1 MAX blocks 315, 320 may be connected to separate inputs of a third 2:1 MAX block 325. The third 2:1 MAX block 325 may be configured to output which of the inputs from the first and second 2:1 MAX blocks 315, 320 is a maximum value to a destination storage location 330. Specifically, the third MAX block 325 output may be stored in a low-bit portion 332 of the destination storage location 330. A high-bit portion 334 of the destination storage location 330 may be left unused. Similar to the first and second storage locations 305, 310, the destination storage location 330 may be implemented using, but not limited to, for example, registers and memory.

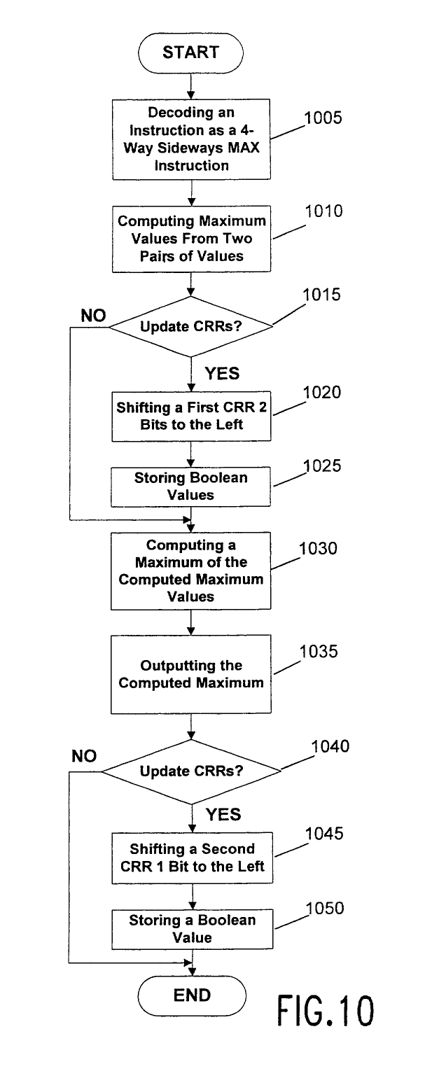

FIG. 10 is a detailed flow diagram of a method for providing a 4-way sideways MAX instruction in a processor, in accordance with an embodiment of the present invention. Since the calculation of both the maximum and minimum of the values involve essentially identical steps, the description of the method for providing the 4-way sideways MAX instruction in a processor may be easily modified to describe a MIN instruction by changing every occurrence of “MAX” with “MIN” and “maximum” with “minimum.” As such, the following description of FIG. 10 may be easily modified to also describe equivalent MIN instructions. Alternatively, the MIN instructions also may be implemented by reversing the polarity of the operands before executing the MAX instruction and then reversing the polarity of the final result.

In FIG. 10, an instruction may be decoded 1005 as a 4-way sideways MAX instruction. Maximum values from two pairs of values may be computed 1010. The need to update a CRR register may be determined 1015, and if the CRR needs to be updated, the bits of a first CRR, for example, CRR0 230, may be shifted 1020 to the left by two (2) bits and Boolean values may be stored 1025 in CRR0 230. Each of the stored Boolean values are associated with one of the two pairs of values and indicate which value from the associated pair of values was determined to be the maximum value.

In FIG. 10, regardless of whether the first CRR was updated, a maximum of the computed maximum values may be computed 1030. The maximum of the computed maximum values may be output 1035 and whether the CRRs are to be updated may be determined 1040. If the CRRs are to be updated 1040, then a second CRR, for example, CRR1 235, may be shifted 1045 one (1) bit to the left and a Boolean value, indicating which one of the computed maximum values is the maximum, may be stored 1050 in CRR1 235. The 4-way sideways MAX instruction may terminate.

In accordance with an embodiment of the present invention, and similar to the 4-way sideways MAX instruction, a 4-way SIMD parallel MAX instruction may be implemented to compute maximum values for four pairs of input values. For example, the 4-way SIMD parallel MAX instruction may compute maximum values from four (4) pairs of operands derived from the four (4) input values, optionally update a first CRR, compute two (2) maximums of the computed maximum values, store the two (2) computed maximum values, and optionally update a second CRR. Specifically, the syntax of the 4-way SIMD parallel MAX instruction with four (4) input values may be represented by:

[CRR]destR=DMAX4(srcA,srcb,srcC,srcD)

where square brackets ([ ]) denote optional instruction parameters that are not required for execution of the instruction.

In accordance with an embodiment of the present invention, the 4-way SIMD parallel MAX instruction described below, generally, may be completely executed over two (2) processor clock cycles. However, it should be clearly understood that the 4-way SIMD parallel MAX instruction also may be implemented to be executed over a single clock cycle as well as over three (3) or more clock cycles. In the following examples, the syntax used may include variables such as signal′ and signal″, which are delayed versions of a variable signal by one and two cycles, respectively.

In accordance with an embodiment of the present invention, the 4-way SIMD parallel MAX instruction may be defined by the following C-style pseudo-code example:

First cycle:

Compute pairs of MAX values

tmp0=MAX(srcA.1, srcB.1)

tmp1=MAX(srcA.h, srcB.h)

tmp2=MAX(srcC.1, srcD.1)

tmp3=MAX(srcC.h, srcD.h)

Update CRR0

If CRR

| { | |
|---|---|
| Shift CRR0 left by 4 | |
| CRR0[4i] | = srcA.l > srcB.l |
| CRR0[4i + 1] | = srcA.h > srcB.h |
| CRR0[4I + 2] | = srcC.l > srcD.l |
| CRR0[4i + 3] | = srcC.h > srcD.h |
| } | |

Second cycle:

Compute MAX values of first cycle MAX values

destR.1=MAX(tmp0′, tmp2′)

destR.h=MAX(tmp1′, tmp3′)

Update CRR1

If CRR

| { | |
|---|---|
| Shift CRR1 left by 2 | |
| CRR1 [2i] | = tmp0' > tmp2' |
| CRR1 [2I + 1] | = tmp1' > tmp3' |
| } | |

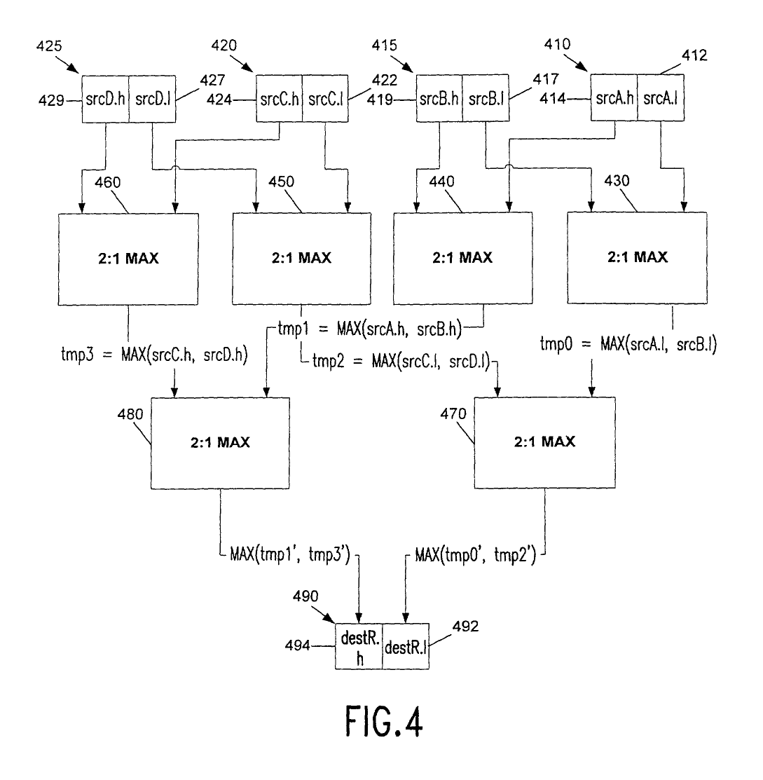

FIG. 4 is a detailed block diagram of a circuit for providing the four-way (4-way) SIMD Parallel MAX instruction in a processor, in accordance with an embodiment of the present invention. In FIG. 4, a first storage location 410 may include a first storage area 412 to store a low-bit portion of a first input value and a second storage area 414 to store a high-bit portion of the first input value. A second storage location 415 may include a first storage area 417 to store a low-bit portion of a second input value and a second storage area 419 to store a high-bit portion of the second input value. A third storage location 420 may include a first storage area 422 to store a low-bit portion of a third input value and a second storage area 424 to store a high-bit portion of the third input value. A fourth storage location 425 may include a first storage area 427 to store a low-bit portion of a fourth input value and a second storage area 429 to store a high-bit portion of the second input value. The first, second, third and fourth storage locations 410, 415, 420 and 420 may be implemented using, but not limited to, for example, registers and memory.

In FIG. 4, the first storage location 410 first storage area 412 and the second storage location 415 first storage area 417 may be connected to separate inputs of a first 2:1 MAX block 430, which is configured to output the maximum of the inputs from storage areas 412 and 417. The first storage location 410 second storage area 414 and the second storage location 415 second storage area 419 may be connected to separate inputs of a second 2:1 MAX block 440, which is configured to output the maximum of the inputs from storage areas 414 and 419. The third storage location 420 first storage area 422 and the fourth storage location 425 first storage area 427 may be connected to separate inputs of a third 2:1 MAX block 450, which is configured to output the maximum of the inputs from storage areas 422 and 427. The third storage location 420 second storage area 424 and the fourth storage location 415 second storage area 429 may be connected to separate inputs of a fourth 2:1 MAX block 460, which is configured to output the maximum of the inputs from storage areas 424 and 429. Each of the first through fourth 2:1 MAX blocks 430, 440, 450 and 460 may be configured to output which of their respective two inputs from the connected storage areas 412, 414, 417, 419, 422, 424, 427 and 429 is a maximum value. The first and third 2:1 MAX blocks 430, 450 may be connected to separate inputs of a fifth 2:1 MAX block 470. The fifth 2:1 MAX block 470 may be configured to output which of the inputs from the first and third 2:1 MAX blocks 430, 450 is a maximum value to a destination storage location 490. Specifically, the fifth 2:1 MAX block 470 output may be stored in a low-bit portion 492 of the destination storage location 490. The second and fourth 2:1 MAX blocks 440, 470 may be connected to separate inputs of a sixth 2:1 MAX block 480. The sixth 2:1 MAX block 480 may be configured to output which of the inputs from the second and fourth 2:1 MAX blocks 440, 470 is a maximum value to the destination storage location 490. Specifically, the sixth 2:1 MAX block 480 output may be stored in a high-bit portion 494 of the destination storage location 490. Similar to the first through fourth storage locations 410, 415, 420 and 425, the destination storage location 492 may be implemented using, but not limited to, for example, registers and memory.

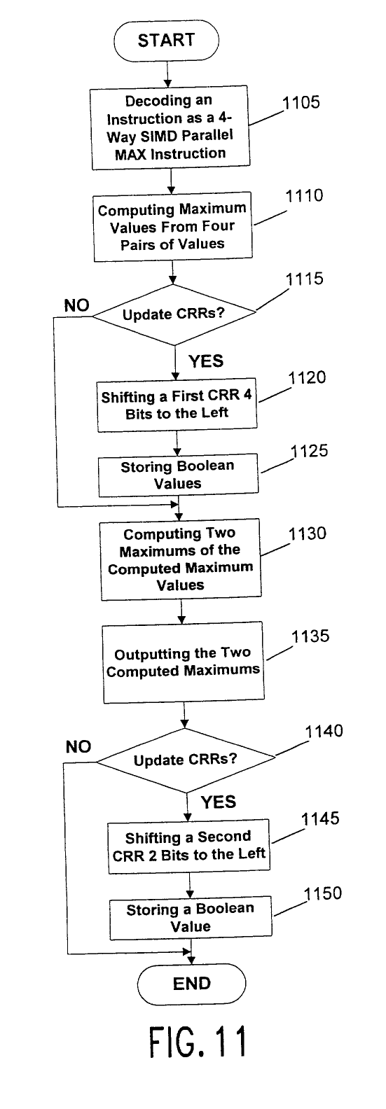

FIG. 11 is a detailed flow diagram of a method for providing a 4-way SIMD parallel MAX instruction in a processor, in accordance with an embodiment of the present invention. As was the case with FIG. 10, since the calculation of both the maximum and minimum of the values involve essentially identical steps, the description of the method for providing the 4-way SIMD parallel MAX instructions in a processor may be easily modified to describe a MIN instruction by changing every occurrence of “MAX” with “MIN” and “maximum” with “minimum.” As such, the following description of FIG. 11 may be easily modified to also describe equivalent MIN instructions. Alternatively, the MIN instructions also may be implemented by reversing the polarity of the operands before executing the MAX instruction and then reversing the polarity of the final result. In embodiments of the 4-way SIMD parallel MAX instruction, although the 4-way SIMD parallel MAX instruction may include 4 input values, separate maximums are determined between two different input values in parallel. Therefore, the 4-way SIMD parallel MAX instruction is a dual MAX instruction.

In FIG. 11, an instruction may be decoded 1105 as a 4-way SIMD parallel MAX instruction. Maximum values from four (4) pairs of values may be computed 1110. The need to update a CRR register may be determined 1115, and if the CRR needs to be updated, the bits of a first CRR, for example, CRR0 230, may be shifted 1120 to the left by four (4) bits and four (4) Boolean values may be output 1125 to CRR0235. Each of the stored Boolean values are associated with one of the four pairs of values and indicate which value from the associated pair of values was determined to be the maximum value.

In FIG. 11, regardless of whether the first CRR was updated, a maximum of the computed maximum values may be computed 1130. The maximum of the computed maximum values may be output 1135 and whether the CRRs are to be updated can be determined 1140. If the CRRs are to be updated 1140, then a second CRR, for example, CRR1 235, can be shifted 1145 two (2) bits to the left and two (2) Boolean values may be stored 1150 in CRR1 235. The 4-way SIMD parallel MAX instruction may terminate.

In accordance with an embodiment of the present invention, and similar to the 4-way sideways MAX instruction, an eight-way (8-way) sideways MAX instruction may be implemented to compute maximum values for eight (8) pairs of input values. For example, the 8-way sideways MAX instruction may compute maximum values from four (4) pairs of operands derived from the two (2) input values, optionally update a first CRR, compute two (2) maximums of the computed maximum values, store the two (2) computed maximum values, and optionally update a second CRR. Specifically, the syntax of the 8-way sideways MAX instruction with two (2) input values may be represented by:

[CRR]destR=MAX8(srcA,srcB)

where square brackets ([ ]) denote optional instruction parameters that are not required for execution of the instruction and each input value has four (4) operands.

In accordance with an embodiment of the present invention, the 8-way sideways MAX instruction described below, generally, may be completely executed over two (2) processor clock cycles. However, it should be clearly understood that the 8-way sideways MAX instruction also may be implemented to be executed over a single clock cycle as well as over three (3) or more clock cycles. In the following examples, the syntax used may include variables such as signal′ and signal″, which are delayed versions of a variable signal by one (1) and two (2) cycles, respectively.

In accordance with an embodiment of the present invention, the 8-way sideways MAX instruction may be defined by the following C-style pseudo-code example:

First cycle:

Compute pairs of MAX values

tmp0=MAX(srcA.a, srcA.b)

tmp1=MAX(srcA.c srcA.d)

tmp2=MAX(srcB.a, srcB.b)

tmp3=MAX(srcB.c, srcB.d)

Update CRR0

If CRR

| { | |
|---|---|
| Shift CRR0 left by 4 | |
| CRR0[2i] | = srcA.a > srcA.b |
| CRR0[2i + 1] | = srcB.c > srcA.d |
| CRR0[2i + 2] | = srcB.a > srcB.b |
| CRR0[2i + 3] | = srcB.c > srcB.d |
| } | |

Compute pair of MAX values of the first computed MAX values

tmp4=MAX(tmp0, tmp1)

tmp5=MAX(tmp2,tmp3)

Update CRR1

If CRR

{
Shift CRR1 left by 2
CRR1[i] = tmp0' > tmp1'
CRR1[i + 1] = tmp2' > tmp3'
}

Second cycle:

Compute MAX of the computed pair of MAX values

destR.1=MAX(tmp4′, tmp5′)

Update CRR2

If CRR

{
Shift CRR2 left by 1
CRR2[i] = tmp0' > tmp1'
}

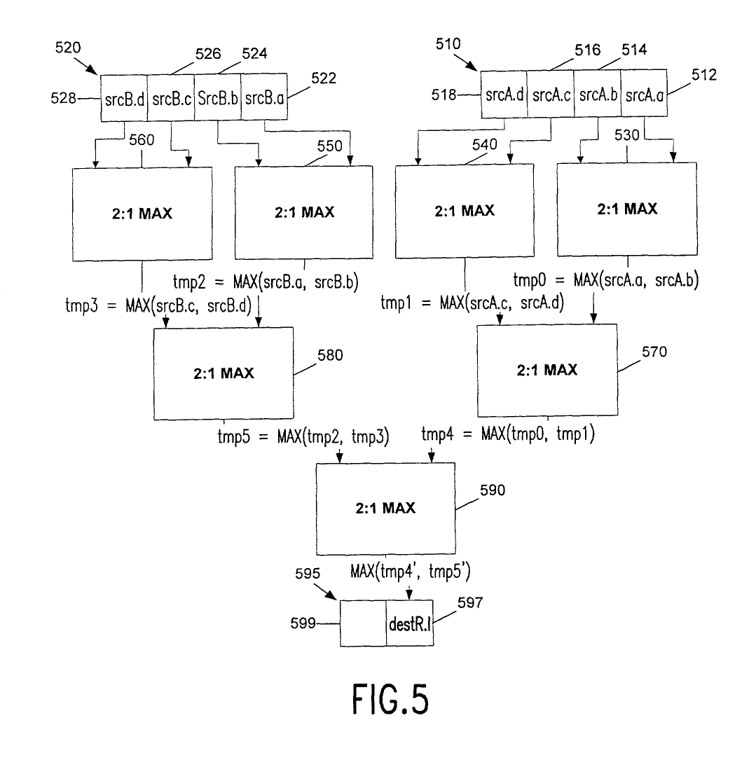

FIG. 5 is a detailed block diagram of a circuit for providing an eight-way (8-way) sideways MAX instruction in a processor, in accordance with an embodiment of the present invention. In FIG. 5, a first storage location 510 may include a first storage area 512 to store a first operand of a first input value, a second storage area 514 to store a second operand of the first input value, a third storage area 516 to store a third operand of the first input value and a fourth storage area 518 to store a fourth operand of the first input value. A second storage location 520 may include a first storage area 522 to store a first operand of a second input value, a second storage area 524 to store a second operand of the second input value, a third storage area 526 to store a third operand of the second input value and a fourth storage area 528 to store a fourth operand of the second input value. The first and second storage locations 510, 520 may be implemented using, but not limited to, for example, registers and memory.

In FIG. 5, the first storage location 520 first storage area 512 and second storage area 514 may be connected to separate inputs of a first 2:1 MAX block 530, which is configured to output the maximum of the inputs from storage areas 512 and 514. The first storage location 510 third storage area 516 and fourth storage area 518 may be connected to separate inputs of a second 2:1 MAX block 540, which is configured to output the maximum of the inputs from storage areas 516 and 518. The second storage location 520 first storage area 522 and second storage area 524 may be connected to separate inputs of a third 2:1 MAX block 550, which is configured to output the maximum of the inputs from storage areas 522 and 524. The second storage location 520 third storage area 526 and fourth storage area 528 may be connected to separate inputs of a fourth 2:1 MAX block 560, which is configured to output the maximum of the inputs from storage areas 526 and 528. Each of the first through fourth 2:1 MAX blocks 530, 540, 550 and 560 may be configured to output which of their respective two inputs from the connected storage areas 512, 514, 516, 518, 522, 524, 526 and 528 is a maximum value. The first and second 2:1 MAX blocks 530, 540 may be connected to separate inputs of a fifth 2:1 MAX block 570. The fifth 2:1 MAX block 570 may be configured to output which of the inputs from the first and second 2:1 MAX blocks 530, 540 is a maximum value. The third and fourth 2:1 MAX blocks 550, 560 may be connected to separate inputs of a sixth 2:1 MAX block 580. The sixth 2:1 MAX block 580 may be configured to output which of the inputs from the third and fourth 2:1 MAX blocks 550, 560 is a maximum value. The fifth and sixth 2:1 MAX blocks 570, 580 may be connected to separate inputs of a seventh 2:1 MAX block 590. The seventh 2:1 MAX block 590 may be configured to output which of the inputs from the fifth and sixth 2:1 MAX blocks 570, 580 is a maximum value to a destination storage location 595. Specifically, the seventh 2:1 MAX block 590 output may be stored in a low-bit portion 597 of the destination storage location 595. A high-bit portion 599 of the destination storage location 595 may be left unused. Similar to the first and second storage locations 510, 520, the destination storage location 595 may be implemented using, but not limited to, for example, registers and memory.

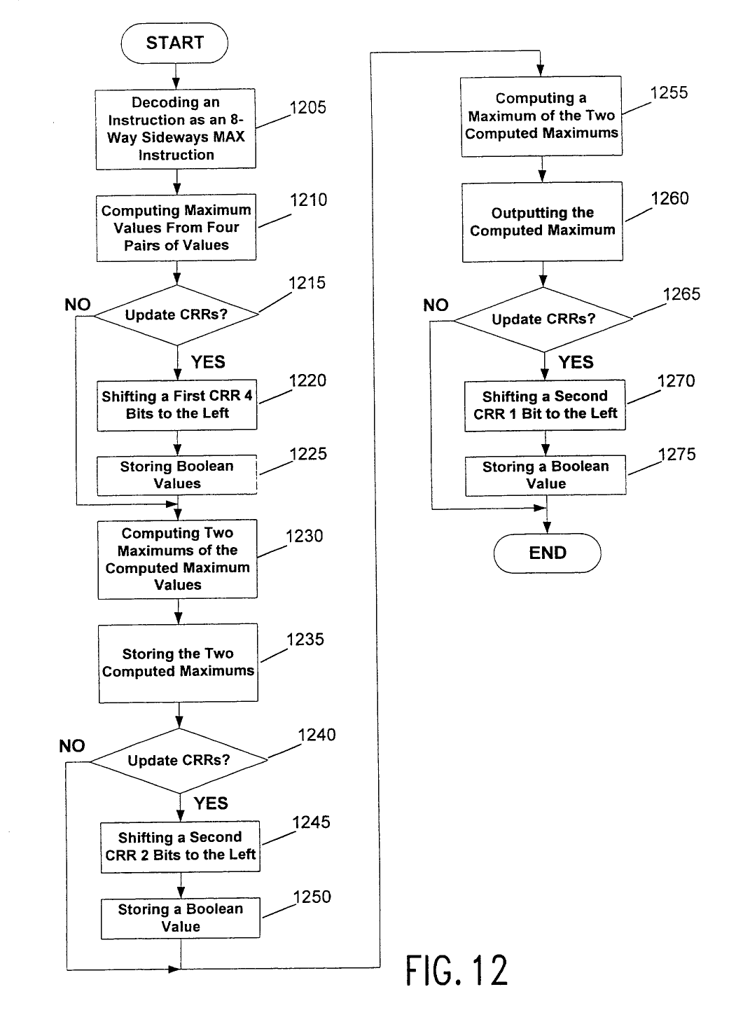

FIG. 12 is a detailed flow diagram of a method for providing an 8-way sideways MAX instruction in a processor, in accordance with an embodiment of the present invention. As was the case with FIGS. 10 and 11, since the calculation of both the maximum and minimum of the values involve essentially identical steps, the description of the method for providing the 8-way sideways MAX instructions in a processor may be easily modified to describe a MIN instruction by changing every occurrence of “MAX” with “MIN” and “maximum” with “minimum.” As such, the following description of FIG. 12 may be easily modified to also describe equivalent MIN instructions. Alternatively, the MIN instructions also may be implemented by reversing the polarity of the operands before executing the MAX instruction and then reversing the polarity of the final result. In the 8-way sideways MAX instruction in accordance with an embodiment of the present invention, although the 8-way sideways MAX instruction may only include 2 input values, each input value may include four (4) separate operands so that separate maximums may be determined between four pairs made from the 8 total operands.

In FIG. 12, an instruction may be decoded 1205 as an 8-way sideways MAX instruction. Maximum values from four (4) pairs of values may be computed 1210. The need to update a CRR register may be determined 1215, and if the CRR needs to be updated, the bits of a first CRR, for example, CRR0 230, may be shifted 1220 to the left by four (4) bits and Boolean values may be stored 1225 in CRR0 230. Each of the stored Boolean values are associated with one of the four pairs of values and indicate which value from the associated pair of values was determined to be the maximum value.

In FIG. 12, regardless of whether the first CRR was updated, two maximum values may be computed 1230. The two computed maximum values may be stored 1235 and whether the CRRs are to be updated can be determined 1240. If the CRRs are to be updated 1240, then a second CRR, for example, CRR1 235, can be shifted 1245 two (2) bits to the left and two (2) Boolean values may be stored 1250 in CRR1 235.

In FIG. 12, regardless of whether the first CRR was updated, a maximum of the two computed maximum values may be computed 1255. The maximum of the two computed maximum values may be output 1260 and whether the CRRs are to be updated may be determined 1265. If the CRRs are to be updated 1265, then a third CRR, for example, CRR2, may be shifted 1270 one (1) bit to the left and a Boolean value, indicating which one of the two computed maximum values is the maximum, may be stored 1275 in CRR2. The 8-way sideways MAX instruction may terminate.

In accordance with an embodiment of the present invention, the generalized 4-way sideways MIN instruction may be implemented to compute the minimum values from two (2) pairs of operands derived from the two (2) input values, optionally update a first CRR, compute a minimum of the computed minimum values, store the computed minimum value, and optionally update a second CRR. Specifically, the generic syntax of the 4-way sideways MIN instruction with four (4) input values may be represented by:

[CRR]destR=MIN4(srcA,srcB)

where the square brackets ([ ]) denote the optional instruction parameters that are not required for execution of the instruction.

In accordance with an embodiment of the present invention, the instructions described below may be, generally, completely executed over two (2) processor clock cycles. However, it should be clearly understood that the instructions also may be implemented to execute over a single clock cycle as well as over three (3) or more clock cycles. In the following examples, the syntax used may include variables such as signal′ and signal″, which are delayed versions of a variable signal by one and two cycles, respectively.

In accordance with an embodiment of the present invention, the functionality of the 4-way sideways MIN instruction may be defined by the following C-style pseudo-code example:

First cycle:

Compute pairs of MIN values

tmp0=MIN (srcA.1, srcA.h)

tmp1=MIN (srcB.1, srcB.h)

Update CRR0

If CRR

| { | |
|---|---|
| Shift CRR0 left by 2 | |
| CRR0[2i] | = srcA.1 < srcA.h |
| CRR0[2i + 1] | = srcB.1 < srcB.h |
| } | |

Second cycle:

Compute MIN of the first cycle MIN values

destR.1=MIN (tmp0′, tmp1′)

Update CRR1

If CRR

{
Shift CRR1 left by 1
CRR0[i] = tmp0' < tmp1'
}

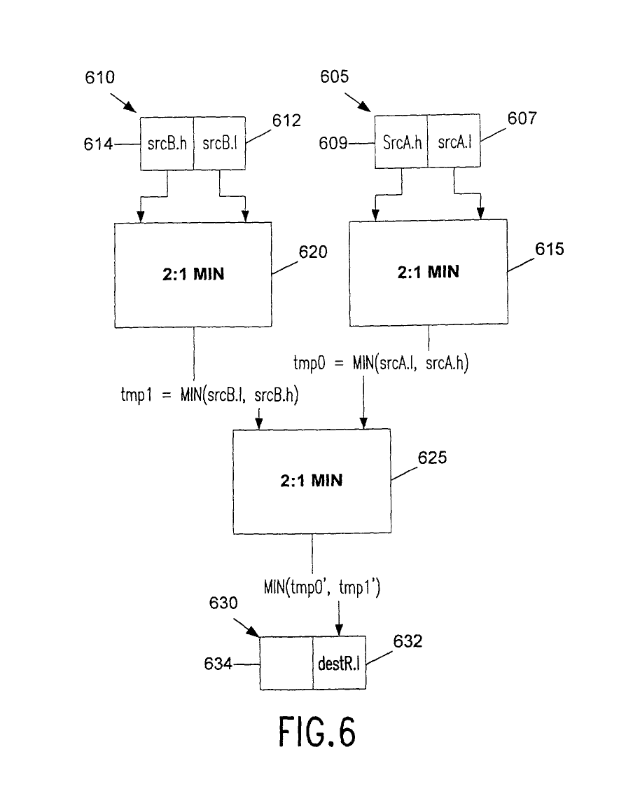

FIG. 6 is a detailed block diagram of a circuit for providing four-way (4-way) MIN sideways instructions in a processor, in accordance with an embodiment of the present invention. In FIG. 6, a first storage location 605 may include storage areas 607, 609 to store a low-bit portion of a first input value and a high-bit portion of the first input value, respectively. Similarly, a second storage location 610 may include storage areas 612, 614 to store a low-bit portion of a second input value and a high-bit portion of the second input value, respectively. The first and second storage locations 605, 610 may be implemented using, but not limited to, for example, registers and memory. Each of the first storage location 605 storage areas 607, 609 may be connected to separate inputs of a first 2:1 MIN block 615, and each of the second storage location 610 storage areas 612, 614 may be connected to separate input lines of a second 2:1 MIN block 620. Each of the first and second 2:1 MIN blocks 615, 620 may be configured to output which of the two inputs from their connected storage areas 607, 609 and 612, 614, respectively, is a minimum value. The first and second 2:1 MIN blocks 615, 620 may be connected to separate inputs of a third 2:1 MIN block 625. The third 2:1 MIN block 325 may be configured to output which of the inputs from the first and second 2:1 MIN blocks 615, 620 is a minimum value to a destination storage location 630. Specifically, the third MIN block 625 output may be stored in a low-bit portion 632 of the destination storage location 630. A high-bit portion 634 of the destination storage location 630 may be left unused. Similar to the first and second storage locations 605, 610, the destination storage location 630 may be implemented using, but not limited to, for example, registers and memory.

In accordance with an embodiment of the present invention, and similar to the 4-way sideways MIN instruction, the 4-way SIMD parallel MIN instruction may be implemented to determine minimum values for four pairs of input values. For example, the 4-way SIMD parallel MIN instruction may compute minimum values from four (4) pairs of operands derived from the four (4) input values, optionally update a first CRR, compute two (2) minimums of the computed minimum values, store the two (2) computed minimum values, and optionally update a second CRR. Specifically, the syntax of the 4-way SIMD parallel MIN instruction may be represented by:

[CRR]destR=DMIN4(srcA,srcB,srcC,srcD)

where square brackets ([ ]) denote optional instruction parameters that are not required for execution of the instruction.

In accordance with an embodiment of the present invention, the 4-way SIMD parallel MIN instruction described below may be, generally, completely executed over two (2) processor clock cycles. However, it should be clearly understood that the 4-way SIMD parallel MIN instruction also may be implemented to be executed over a single clock cycle as well as over three (3) or more clock cycles. In the following examples, the syntax used may include variables such as signal′ and signals″, which are delayed versions of a variable signal by one (1) and two (2) cycles, respectively.

In accordance with an embodiment of the present invention, the 4-way SIMD parallel MIN instruction may be defined by the following C-style pseudo-code example:

First cycle:

Compute pairs of MIN values

tmp0=MIN (srcA.1, srcB.1)

tmp1=MIN (srcA.h, srcB.h)

tmp2=MIN (srcC.1, srcD.1)

tmp3=MIN (srcC.h, srcD.h)

Update CRR0

| { | |
|---|---|
| Shift CRR0 left by 4 | |
| CRR0[4i] | = srcA.l < srcB.l |
| CRR0[4i + 1] | = srcA.h < srcB.h |
| CRR0[4i + 2] | = srcC.l < srcD.l |
| CRR0[4i + 3] | = srcC.h < srcD.h |
| } | |

If CRR

Second cycle:

Compute MIN values of first cycle MIN values

destR.1=MIN (tmp0′, tmp2′)

destR.h=MIN (tmp1′, tmp3′)

Update CRR1

If CRR

| { | |
|---|---|
| Shift CRR1 left by 2 | |
| CRR1[2i] | = tmp0' < tmp2' |
| CRR1[2i + 1] | = tmp1' < tmp3' |
| } | |

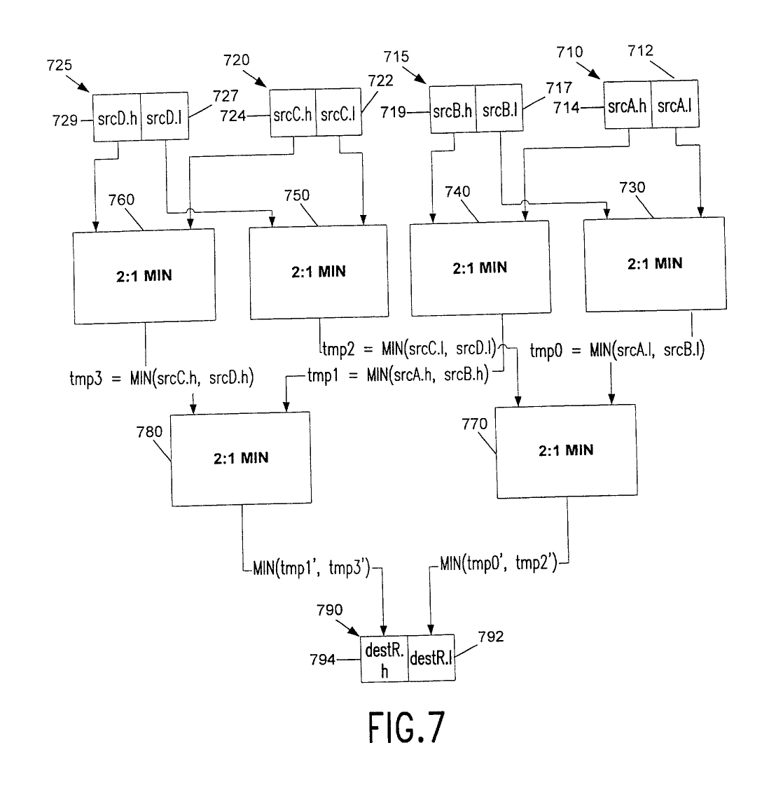

FIG. 7 is a detailed block diagram of a circuit for providing a four-way (4-way) SIMD Parallel MIN instruction in a processor, in accordance with an embodiment of the present invention. In FIG. 7, a first storage location 710 may include a first storage area 712 to store a low-bit portion of a first input value and a second storage area 714 to store a high-bit portion of the first input value. A second storage location 715 may include a first storage area 717 to store a low-bit portion of a second input value and a second storage area 719 to store a high-bit portion of the second input value. A third storage location 720 may include a first storage area 722 to store a low-bit portion of a third input value and a second storage area 724 to store a high-bit portion of the third input value. A fourth storage location 725 may include a first storage area 727 to store a low-bit portion of a fourth input value and a second storage area 729 to store a high-bit portion of the second input value. The first, second, third and fourth storage locations 710, 715, 720 and 720 may be implemented using, but not limited to, for example, registers and memory.

In FIG. 7, the first storage location 710 first storage area 712 and the second storage location 715 first storage area 717 may be connected to separate inputs of a first 2:1 MIN block 730, which is configured to output the minimum of the inputs from storage areas 712 and 717. The first storage location 710 second storage area 714 and the second storage location 715 second storage area 719 may be connected to separate inputs of a second 2:1 MIN block 740, which is configured to output the minimum of the inputs from storage areas 714 and 719. The third storage location 720 first storage area 722 and the fourth storage location 725 first storage area 727 may be connected to separate inputs of a third 2:1 MIN block 750, which is configured to output the minimum of the inputs from storage areas 722 and 727. The third storage location 720 second storage area 724 and the fourth storage location 715 second storage area 729 may be connected to separate inputs of a fourth 2:1 MIN block 760, which is configured to output the minimum of the inputs from storage areas 724 and 729. Each of the first through fourth 2:1 MIN blocks 730, 740, 750 and 760 may be configured to output which of their respective two inputs from the connected storage areas 712, 714, 717, 719, 722, 724, 727 and 729 is a minimum value. The first and third 2:1 MIN blocks 730, 750 may be connected to separate inputs of a fifth 2:1 MIN block 770. The fifth 2:1 MIN block 770 may be configured to output which of the inputs from the first and third 2:1 MIN blocks 730, 750 is a minimum value to a destination storage location 790. Specifically, the fifth 2:1 MIN block 770 output may be stored in a low-bit portion 792 of the destination storage location 790. The second and fourth 2:1 MIN blocks 740, 770 may be connected to separate inputs of a sixth 2:1 MIN block 780. The sixth 2:1 MIN block 780 may be configured to output which of the inputs from the second and fourth 2:1 MIN blocks 740, 770 is a maximum value to the destination storage location 790. Specifically, the sixth 2:1 MIN block 780 output may be stored in a high-bit portion 794 of the destination storage location 790. Similar to the first through fourth storage locations 710, 715, 720 and 725, the destination storage location 792 may be implemented using, but not limited to, for example, registers and memory.

In accordance with an embodiment of the present invention, and similar to the 4-way sideways MIN instruction, an eight-way (8-way) sideways MIN instruction may be implemented to compute minimum values for eight (8) pairs of input values. For example, the 8-way sideways MIN instruction may compute minimum values from eight (8) pairs of operands derived from the two (2) input values, optionally update a first CRR, compute two (2) minimums of the computed minimum values, store the two (2) computed minimum values, and optionally update a second CRR. Specifically, the syntax of the 8-way sideways MIN instruction with two (2) input values may be represented by:

[CRR]destR=MIN8(srcA,srcB)

where square brackets ([ ]) denote optional instruction parameters that are not required for execution of the instruction and each input value has four (4) operands.

In accordance with an embodiment of the present invention, the 8-way sideways MIN instruction described below, generally, may be completely executed over two (2) processor clock cycles. However, it should be clearly understood that the 8-way sideways MIN instruction also may be implemented to be executed over a single clock cycle as well as over three (3) or more clock cycles. In the following examples, the syntax used may include variables such as signal′ and signal″, which are delayed versions of a variable signal by one (1) and two (2) cycles, respectively.

In accordance with an embodiment of the present invention, the 8-way sideways MIN instruction may be defined by the following C-style pseudo-code example:

First cycle:

Compute pairs of MIN values

tmp0=MIN (srcA.a, srcA.b)

tmp1=MIN (srcA.c srcA.d)

tmp2=MIN (srcB.a, srcB.b)

tmp3=MIN (srcB.c, srcB.d)

Update CRR0

If CRR

| { | |
|---|---|
| Shift CRR0 left by 4 | |
| CRR0[2i] | = srcA.a < srcA.b |
| CRR0[2i + 1] | = srcB.c < srcA.d |
| CRR0[2i + 2] | = srcB.a < srcB.b |
| CRR0[2i + 3] | = srcB.c < srcB.d |
| } | |

Compute pair of MIN values of the first computed MIN values

tmp4=MIN (tmp0, tmp1)

tmp5=MIN (tmp2,tmp3)

Update CRR1

If CRR

{
Shift CRR1 left by 2
CRR1[i] = tmp0' < tmp1'
gCRR1[i + 1] = tmp2' < tmp3'
}

Second cycle:

Compute MIN of the computed pair of MIN values

destR.1=MIN (tmp4′, tmp5′)

Update CRR2

If CRR

{
Shift CRR2 left by 1
CRR2[i] = tmp0' < tmp1'
}

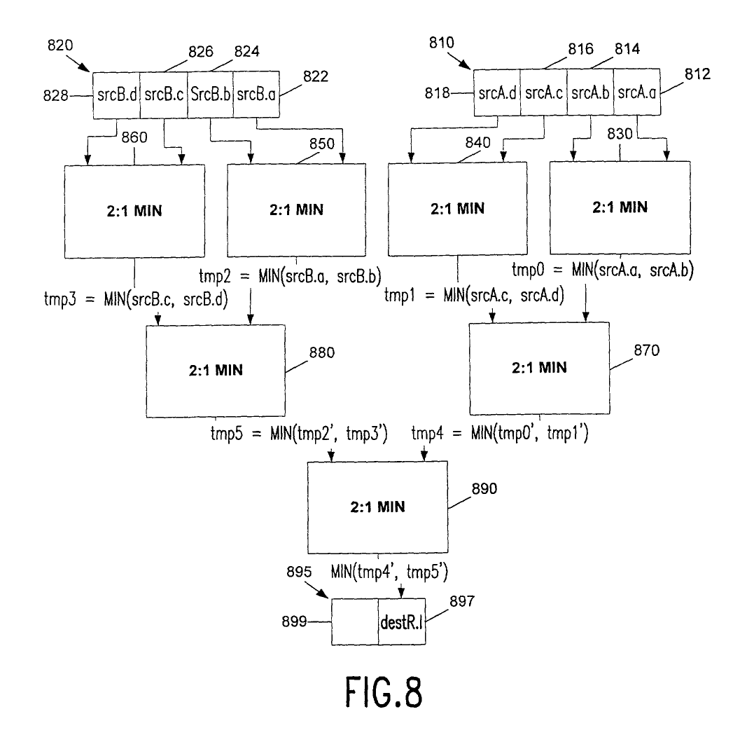

FIG. 8 is a detailed block diagram of a circuit for providing an eight-way (8-way) sideways MIN instruction in a processor, in accordance with an embodiment of the present invention. In FIG. 8, a first storage location 810 may include a first storage area 812 to store a first operand of a first input value, a second storage area 814 to store a second operand of the first input value, a third storage area 816 to store a third operand of the first input value and a fourth storage area 818 to store a fourth operand of the first input value. A second storage location 820 may include a first storage area 822 to store a first operand of a second input value, a second storage area 824 to store a second operand of the second input value, a third storage area 826 to store a third operand of the second input value and a fourth storage area 828 to store a fourth operand of the second input value. The first and second storage locations 810, 820 may be implemented using, but not limited to, for example, registers and memory.

In FIG. 8, the first storage location 820 first storage area 812 and second storage area 814 may be connected to separate inputs of a first 2:1 MIN block 830, which is configured to output the minimum of the inputs from storage areas 812 and 814. The first storage location 810 third storage area 816 and fourth storage area 818 may be connected to separate inputs of a second 2:1 MIN block 840, which is configured to output the minimum of the inputs from storage areas 816 and 818. The second storage location 820 first storage area 822 and second storage area 824 may be connected to separate inputs of a third 2:1 MIN block 850, which is configured to output the minimum of the inputs from storage areas 822 and 824. The second storage location 820 third storage area 826 and fourth storage area 828 may be connected to separate inputs of a fourth 2:1 MIN block 860, which is configured to output the minimum of the inputs from storage areas 826 and 828. Each of the first through fourth 2:1 MIN blocks 830, 840, 850 and 860 may be configured to output which of their respective two inputs from the connected storage areas 812, 814, 816, 818, 822, 824, 826 and 828 is a minimum value. The first and second 2:1 MIN blocks 830, 840 may be connected to separate inputs of a fifth 2:1 MIN block 870. The fifth 2:1 MIN block 870 may be configured to output whichever of the inputs from the first and second 2:1 MIN blocks 530, 540 is a minimum value. The third and fourth 2:1 MIN blocks 850, 860 may be connected to separate inputs of a sixth 2:1 MIN block 880. The sixth 2:1 MIN block 880 may be configured to output whichever of the inputs from the third and fourth 2:1 MIN blocks 850, 860 is a maximum value. The fifth and sixth 2:1 MIN blocks 870, 880 may be connected to separate inputs of a seventh 2:1 MIN block 890. The seventh 2:1 MIN block 890 may be configured to output which of the inputs from the fifth and sixth 2:1 MIN blocks 870, 880 is a minimum value to a destination storage location 895. Specifically, the seventh 2:1 MIN block 890 output may be stored in a low-bit portion 897 of the destination storage location 895. A high-bit portion 899 of the destination storage location 895 may be left unused. Similar to the first and second storage locations 810, 820, the destination storage location 895 may be implemented using, but not limited to, for example, registers and memory.

In accordance with an embodiment of the present invention, a method for providing a 2^{N}-way comparison instruction in N stages in a processor. The method includes decoding an instruction as one of a 2^{N}-way MAX instruction and a 2^{N}-way MIN instruction. The method also includes computing a maximum value for each of a plurality of pairs of values, if the decoded instruction is the 2^{N}-way MAX instruction, otherwise, computing a minimum value for each of the plurality of pairs of values, if said decoded instruction is the 2^{N}-way MIN instruction. The method further includes computing a maximum of the computed maximum values, if the decoded instruction is the 2^{N}-way MAX instruction, otherwise, computing a minimum of the computed minimum values, if the decoded instruction is the 2^{N}-way MIN instruction. The method further includes outputting the computed maximum of the computed maximum values, if the decoded instruction is the 2^{N}-way MAX instruction, otherwise, outputting the computed minimum of the computed minimum values, if the decoded instruction is the 2^{N}-way MIN instruction.

In accordance with an embodiment of the present invention, a processor includes a decoder to decode an instruction as one of a 2^{N}-way MAX instruction and a 2^{N}-way MIN instruction; and a circuit coupled to the decoder. The circuit, in response to the decoded instruction to compute a maximum value for each of a plurality of pairs of values, if the decoded instruction is the 2^{N}-way MAX instruction, otherwise, compute a minimum value for each of a plurality of pairs of values, if the decoded instruction is the 2^{N}-way MIN instruction. The circuit also to compute a maximum of the computed maximum values, if the decoded instruction is the 2^{N}-way MAX instruction, otherwise, compute a minimum of the computed minimum values, if the decoded instruction is the 2^{N}-way MIN instruction. The circuit further to output the computed maximum of the computed maximum values, if the decoded instruction is the 2^{N}-way MAX instruction, otherwise, output the computed minimum of the computed minimum values, if the decoded instruction is the 2^{N}-way MIN instruction.

In accordance with an embodiment of the present invention including, a computer system including a processor and a machine-readable medium coupled to the processor in which is stored one or more instructions adapted to be executed by the processor. The instructions which, when executed, configure the processor to decode an instruction as one of a 2^{N}-way MAX instruction and a 2^{N}-way MIN instruction. The processor is also configured to compute a maximum value for each of a plurality of pairs of values, if the decoded instruction is the 2^{N}-way MAX instruction, otherwise, compute a minimum value for each of a plurality of pairs of values, if the decoded instruction is the 2^{N}-way MIN instruction. The processor is further configured to compute a maximum of the computed maximum values, if the decoded instruction is the 2^{N}-way MAX instruction, otherwise, compute a minimum of the computed minimum values if the decoded instruction is the 2^{N}-way MIN instruction; and output the computed maximum of the computed maximum values, if the decoded instruction is the 2^{N}-way MAX instruction, otherwise, output the computed minimum of the computed minimum values, if the decoded instruction is the 2^{N}-way MIN instruction.

In accordance with an embodiment of the present invention, a machine-readable medium in which is stored one or more instructions adapted to be executed by a processor, the instructions which, when executed, configure the processor to decode an instruction as one of a 2^{N}-way MAX instruction and a 2^{N}-way MIN instruction; and compute a maximum value for each of a plurality of pairs of values, if the decoded instruction is the 2^{N}-way MAX instruction, otherwise, compute a minimum value for each of a plurality of pairs of values, if the decoded instruction is the 2^{N}-way MIN instruction. The processor is further configured to compute a maximum of the computed maximum values, if the decoded instruction is the 2^{N}-way MAX instruction, otherwise, compute a minimum of the computed minimum values if the decoded instruction is the 2^{N}-way MIN instruction; and output the computed maximum of the computed maximum values, if the decoded instruction is the, 2^{N}-way MAX instruction, otherwise, output the computed minimum of the computed minimum values, if the decoded instruction is the 2^{N}-way MIN instruction.

In accordance with an embodiment of the present invention, a method for providing an eight-way comparison instruction in three stages in a processor includes decoding an instruction as one of an eight-way MAX instruction and an eight-way MIN instruction; and computing a maximum value for each of a plurality of pairs of values, if the decoded instruction is the eight-way MAX instruction, otherwise, computing a minimum value for each of a plurality of pairs of values, if the decoded instruction is the eight-way MIN instruction. The method also includes computing a maximum of the computed maximum values, if the decoded instruction is the eight-way MAX instruction, otherwise, computing a minimum of the computed minimum values if the decoded instruction is the eight-way MIN instruction. The method further includes outputting the computed maximum of the computed maximum values, if the decoded instruction is the eight-way MAX instruction, otherwise, outputting the computed minimum of the computed minimum values, if the decoded instruction is the eight-way MIN instruction.

While the embodiments described above relate mainly to 32-bit data path and 32 bit register-based accumulatable packed multi-way addition instruction embodiments, they are not intended to limit the scope or coverage of the present invention. In fact, the method described above may be implemented with different sized data types and processing cores such as, but not limited to, for example, 8-bit, 16-bit, 32-bit and/or 64-bit data.

It should, of course, be understood that while the present invention has been described mainly in terms of microprocessor-based and multiple microprocessor-based personal computer systems, those skilled in the art will recognize that the principles of the invention, as discussed herein, may be used advantageously with alternative embodiments involving other integrated processor chips and computer systems. Accordingly, all such implementations, which fall within the spirit and scope of the appended claims, will be embraced by the principles of the present invention.

What is claimed is:

1. A method for providing a 2^{N}-way comparison instruction in N stages in a processor, the method comprising:
decoding an instruction as one of a 2^{N}-way MAX instruction, and a 2^{N}-way MIN instruction;
computing a maximum value for each of a plurality of pairs of values, if said decoded instruction is said 2^{N}-way MAX instruction, and computing a minimum value for each of the plurality of pairs of values, if said decoded instruction is said 2^{N}-way MIN instruction;
computing a maximum of said computed maximum values, if said decoded instruction is said 2^{N}-way MAX instruction, and computing a minimum of said computed minimum values if said decoded instruction is said 2^{N}-way MIN instruction; and
outputting said computed maximum of said computed maximum values, if said decoded instruction is said 2^{N}-way MAX instruction, and outputting said computed minimum of said computed minimum values, if said decoded instruction is said 2^{N}-way MIN instruction.

2. The method as defined in claim 1 wherein said decoding operation comprises:
decoding said instruction as one of a four-way sideways MAX instruction, and a four-way sideways MIN instruction.

3. The method as defined in claim 2 wherein said computing said maximum values operation comprises:
determining a first maximum value of a first of said plurality of pairs of values, said first pair of values including a first source operand and a second source operand;
storing said determined first maximum value;
determining a second maximum value of a second of said plurality of pairs of values, said second pair of values including a third source operand and a fourth-source operand; and
storing said determined second maximum value.

4. The method as defined in claim 3 wherein said first source operand includes a plurality of low bits from a first of said plurality of operands, said second source operand includes a plurality of high bits from said first of said plurality of operands, said third source operand includes a plurality of low bits from a second of said plurality of operands, and said fourth source operand includes a plurality of high bits from said second of said plurality of operands.

5. The method as defined in claim 3 further comprising:
updating a first control register, if requested by said four-way MAX instruction.

6. The method as defined in claim 5 wherein said updating operation comprises:
shifting said first control register two bits to the left;
storing a first boolean value indicating whether said first source operand is greater than said second source operand; and
storing a second boolean value indicating whether said third source operand is greater than said fourth source operand.

7. The method as defined in claim 6 wherein said first boolean value and said second boolean value are stored in adjacent bits in said first control register.

8. The method as defined in claim 2 wherein said computing said minimum values operation comprises:
determining a first minimum value of a first of said plurality of pairs of values, said first pair of values including a first source operand and a second source operand;
storing said determined first minimum value;
determining a second minimum value of a second of said plurality of pairs of values, said second pair of values including a third source operand and a fourth-source operand; and
storing said determined second minimum value.

9. The method as defined in claim 8 wherein said first source operand includes a plurality of low bits from a first of said plurality of operands, said second source operand includes a plurality of high bits from said first of said plurality of operands, said third source operand includes a plurality of low bits from a second of said plurality of operands, and said fourth source operand includes a plurality of high bits from said second of said plurality of operands.

10. The method as defined in claim 8 further comprising:
updating a first control register, if requested by said four-way MIN instruction.

11. The method as defined in claim 10 wherein said updating operation comprises:
shifting said first control register two bits to the left;
storing a first boolean value indicating whether said first source operand is less than said second source operand; and
storing a second boolean value indicating whether said third source operand is less than said fourth source operand.

12. The method as defined in claim 11 wherein said first boolean value and said second boolean value are stored in adjacent bits in said first control register.

13. The method as defined in claim 1 wherein said computing said maximum of said computed maximum values operation comprises:
determining a final maximum value between said first maximum value and said second maximum value.

14. The method as defined in claim 13 further comprising:
updating a second control register, if requested by said four-way MAX instruction.

15. The method as defined in claim 14 wherein said updating said second control register operation comprises:
shifting said second control register one bit to the left; and
storing a boolean value, said boolean value indicating whether said first maximum value is greater than said second maximum value.

16. The method as defined in claim 1 wherein said computing said minimum of said computed minimum values operation comprises:
determining a final minimum value between said first minimum value and said second minimum value.

17. The method as defined in claim 16 further comprising:
updating a second control register, if requested by said four-way MIN instruction.

18. The method as defined in claim 17 wherein said updating said second control register operation comprises:
shifting said second control register one bit to the left; and
storing a boolean value, said boolean value indicating whether said first minimum value is less than said second minimum value.

19. The method as defined in claim 1 wherein said computing said maximum values operation and said minimum values operation occur during a first processor cycle.

20. The method as defined in claim 1 wherein said computing said maximum of said computed said maximum values operation and said minimum of said computed said minimum values operation occurs during a second processor cycle.

21. The method as defined in claim 1 wherein said decoding operation comprises:
decoding said 2^{N}-way MAX instruction as one of a four-way SIMD parallel MAX instruction, and a four-way SIMD parallel MIN instruction.

22. The method as defined in claim 21 wherein said computing said maximum values operation comprises:
determining a first maximum value of a first of said plurality of pairs of values, said first pair of values including a first source operand and a second source operand;
storing said determined first maximum value;
determining a second maximum value of a second of said plurality of pairs of values, said second pair of values including a third source operand and a fourth source operand;
storing said determined second maximum value;
determining a third maximum value of a third of said plurality of pairs of values, said third pair of values including a fourth source operand and a fifth source operand and a sixth source operand;
storing said determined third maximum value;
determining a fourth maximum value of a fourth of said plurality of pairs of values, said fourth pair of values including a seventh source operand and an eighth source operand; and
storing said determined fourth maximum value.

23. The method as defined in claim 22 wherein said first source operand includes a plurality of low bits from a first of said plurality of operands, said second source operand includes a plurality of low bits from a second of said plurality of operands, said third source operand includes a plurality of high bits from said first of said plurality of operands, said fourth source operand includes a plurality of high bits from said second of said plurality of operands, said fifth source operand includes a plurality of low bits from a third of said plurality of operands, said sixth source operand includes a plurality of low bits from a fourth of said plurality of operands, said seventh source operand includes a plurality of high bits from said third of said plurality of operands, said eighth source operand representing a plurality of high bits from said fourth of said plurality of operands.

24. The method as defined in claim 22 further comprising:
updating a first control register, if requested by said four-way SIMD parallel MAX instruction.

25. The method as defined in claim 24 wherein said updating operation comprises:
shifting said first control register four bits to the left;
storing a first boolean value indicating whether said first source operand is greater than said second source operand;
storing a second boolean value indicating whether said third source operand is greater than said fourth source operand;
storing a third boolean value indicating whether said fourth source operand is greater than said sixth source operand; and
storing a fourth boolean value indicating whether said seventh source operand is greater than said eighth source operand.

26. The method as defined in claim 25 wherein said first boolean value, said second boolean value, said third boolean value and said fourth boolean value are stored in adjacent bits in said first control register.

27. The method as defined in claim 21 wherein said computing said maximum values and said minimum values operations occur during a first processor cycle; and
said computing said maximum of said computed said maximum values operation and said minimum of said computed said minimum values operation occur during a second process cycle.

28. The method as defined in claim 27 wherein said computing minimum values operation comprises:
determining a first minimum value of a first of said plurality of pairs of values, said first pair of values including a first source operand and a second source operand;
storing said determined first minimum value;
determining a second minimum value of a second of said plurality of pairs of values, said second pair of values including a third source operand and a fourth source operand;
storing said determined second minimum value;
determining a third minimum value of a third of said plurality of pairs of values, said third pair of values including a fourth source operand and a fifth source operand and a sixth source operand;
storing said determined third minimum value;
determining a fourth minimum value of a fourth of said plurality of pairs of values, said fourth pair of values including a seventh source operand and an eighth source operand; and
outputting said determined fourth minimum value.

29. The method as defined in claim 28 wherein said first source operand includes a plurality of low bits from a first of said plurality of operands, said second source operand includes a plurality of low bits from a second of said plurality of operands, said third source operand includes a plurality of high bits from said first of said plurality of operands, said fourth source operand includes a plurality of high bits from said second of said plurality of operands, said fifth source operand includes a plurality of high bits from said second of said plurality of operands, said sixth source operand includes a plurality of high bits from said second of said plurality of operands, said seventh source operand includes a plurality of high bits from said second of said plurality of operands, said eighth source operand representing a plurality of high bits from said second of said plurality of operands.

30. The method as defined in claim 28 further comprising:
updating a first control register, if requested by said four-way SIMD parallel MIN instruction.

31. The method as defined in claim 30 wherein said updating operation comprises:
shifting said first control register four bits to the left;
storing a first boolean value indicating whether said first source operand is less than said second source operand;
storing a second boolean value indicating whether said third source operand is less than said fourth source operand;
storing a third boolean value indicating whether said fourth source operand is less than said sixth source operand; and
storing a fourth boolean value indicating whether said seventh source operand is less than said eighth source operand.

32. The method as defined in claim 31 wherein said first boolean value, said second boolean value, said third boolean value and said fourth boolean value are stored in adjacent bits in said first control register.

33. A processor, said processor comprising:
a decoder to decode an instruction as one of a 2^{N}-way MAX instruction, and a 2^{N}-way MIN instruction; and
a circuit coupled to said decoder, said circuit in response to said decoded instruction to
compute a maximum value for each of a plurality of pairs of values, if said decoded instruction is said 2^{N}-way MAX instruction, else compute a minimum value for each of a plurality of pairs of values, if said decoded instruction is said 2^{N}-way MIN instruction;
compute a maximum of said computed maximum values, if said decoded instruction is said 2^{N}-way MAX instruction, else compute a minimum of said computed minimum values if said decoded instruction is said 2^{N}-way MIN instruction; and
output said computed maximum of said computed maximum values, if said decoded instruction is said 2^{N}-way MAX instruction, else store said computed minimum of said computed minimum values, if said decoded instruction is said 2^{N}-way MIN instruction.

34. The processor as defined in claim 33 wherein said circuit comprises one of:
a plurality of 2:1 MAX blocks; and
a plurality of 2:1 MIN blocks.

35. The processor as defined in claim 34 wherein said plurality of 2:1 MAX blocks are configured to execute in at least one processor cycle.

36. The processor as defined in claim 34 wherein said plurality of 2:1 MIN blocks are configured to execute in at least one processor cycle.

37. The processor as defined in claim 34 wherein said circuit further comprises:
N compare result registers.

38. A computer system, said computer system comprising:
a processor; and
a machine readable medium coupled to the processor in which is stored one or more instructions adapted to be executed by the processor, the instructions which, when executed, configure the processor to:
decode an instruction as one of a 2^{N}-way MAX instruction, and a 2^{N}-way MIN instruction;
compute a maximum value for each of a plurality of pairs of values, if said decoded instruction is said 2^{N}-way MAX instruction, else compute a minimum value for each of a plurality of pairs of values, if said decoded instruction is said 2^{N}-way MIN instruction;
compute a maximum of said computed maximum values, if said decoded instruction is said 2^{N}-way MAX instruction, else compute a minimum of said computed minimum values if said decoded instruction is said 2^{N}-way MIN instruction; and
output said computed maximum of said computed maximum values, if said decoded instruction is said 2^{N}-way MAX instruction, else store said computed minimum of said computed minimum values, if said decoded instruction is said 2^{N}-way MIN instruction.

39. The computer system as defined in claim 38 wherein said processor comprises:
a decoder to decode said 2^{N}-way MAX and said 2^{N}-way MIN instructions; and
a circuit coupled to said decoder, said circuit to execute said decoded instructions.

40. The computer system as defined in claim 38 wherein said circuit comprises one of:
a plurality of 2:1 MAX blocks; and
a plurality of 2:1 MIN blocks.

41. The computer system as defined in claim 40 wherein said circuit further comprises:
N compare result registers.

42. A machine-readable medium in which is stored one or more instructions adapted to be executed by a processor, the instructions which, when executed, configure the processor to:
decode an instruction as one of a 2^{N}-way MAX instruction, and a 2^{N}-way MIN instruction;
compute a maximum value for each of a plurality of pairs of values, if said decoded instruction is said 2^{N}-way MAX instruction, else compute a minimum value for each of a plurality of pairs of values, if said decoded instruction is said 2^{N}-way MIN instruction;
compute a maximum of said computed maximum values, if said decoded instruction is said 2^{N}-way MAX instruction, else compute a minimum of said computed minimum values if said decoded instruction is said 2^{N}-way MIN instruction; and
store said computed maximum of said computed maximum values, if said decoded instruction is said 2^{N}-way MAX instruction, else store said computed minimum of said computed minimum values, if said decoded instruction is said 2^{N}-way MIN instruction.

43. The machine-readable medium as defined in claim 42 wherein said decode operation comprises one of:
decode said instruction as a four-way sideways MAX instruction; and
decode said instruction as a four-way SIMD parallel MAX instruction.

44. The machine-readable medium as defined in claim 42 wherein said compute said maximum value operation occurs during a first processor cycle, and said compute said maximum operation occurs during a second processor cycle.

45. A method for providing an eight-way comparison instruction in three stages in a processor, said method comprising:
decoding an instruction as one of an eight-way MAX instruction, and an eight-way MIN instruction;
computing a maximum value for each of a plurality of pairs of values, if said decoded instruction is said eight-way MAX instruction, else computing a minimum value for each of said plurality of pairs of values, if said decoded instruction is said eight-way MIN instruction;
computing a maximum of said computed maximum values, if said decoded instruction is said eight-way MAX instruction, else computing a minimum of said computed minimum values if said decoded instruction is said eight-way MIN instruction; and
outputting said computed maximum of said computed maximum values, if said decoded instruction is said eight-way MAX instruction, else storing said computed minimum of said computed minimum values, if said decoded instruction is said eight-way MIN instruction.

46. The method as defined in claim 45 wherein said computing maximum values operation comprises:
determining a first maximum value of a first of said plurality of pairs of values, said first pair of values including a first source operand and a second source operand;
storing said determined first maximum value;
determining a second maximum value of a second of said plurality of pairs of values, said second pair of values including a third source operand and a fourth source operand;
storing said determined second maximum value;
determining a third maximum value of a third of said plurality of pairs of values, said third pair of values including a fourth source operand and a fifth source operand and a sixth source operand;
storing said determined third maximum value;
determining a fourth maximum value of a fourth of said plurality of pairs of values, said fourth pair of values including a seventh source operand and an eighth source operand; and
storing said determined fourth maximum value.

47. The method as defined in claim 45 wherein said first source operand includes a first plurality of bits from a first of said plurality of operands, said second source operand includes a second plurality of bits from said first of said plurality of operands, said third source operand includes a third plurality of bits from said first of said plurality of operands, said fourth source operand includes a fourth plurality of bits from said first of said plurality of operands, said fifth source operand includes a first plurality of high bits from a said second of said plurality of operands, said sixth source operand includes a second plurality of bits from said second of said plurality of operands, said seventh source operand includes a third plurality of bits from said second of said plurality of operands, said eighth source operand representing a fourth plurality of bits from said second of said plurality of operands.
